(19) United States
(12) Patent Application Publication
(10) Pub. No.: US 2008/0160313 A1
(43) Pub. Date: Jul. 3, 2008

(54) Lipid bilayers on nanotextured solid surfaces

(76) Inventors: Gabriel Lopez, Albuquerque, NM (US); Reema Zeineldin, Albuquerque, NM (US); Darryl Sasaki, Livermore, CA (US); Julie Last, Madison, WI (US)

Correspondence Address: GONZALES PATENT SERVICES, 4605 CONGRESS AVE. NW, ALBUQUERQUE, NM, 87114, US

(21) Appl. No.: 11/796,038

(22) Filed: Apr. 26, 2007

Related U.S. Application Data
(60) Provisional application No. 60/745,716, filed on Apr. 26, 2006.

(51) Int. Cl. B32B 9/00; B05D 1/18

(52) U.S. Cl. 428/409; 427/430.1; 427/443.2

(57) ABSTRACT

The present disclosure provides various novel suspended planar lipid bilayer assemblies made from bicellar mixtures containing long and short chain phospholipids and methods of making the same. Such bilayer assemblies may additionally incorporate biomolecules such as proteins, polypeptides, biological complexes, transmembrane proteins and other membrane-associated compounds. The present disclosure further provides uses for such lipid bilayer assemblies including proteomics, membrane study, biosensing for medical diagnosis and environmental monitoring, chemical and biological warfare agent sequestration, actuator development, and bio-fuel cell development.

### CROSS-REFERENCE TO RELATED APPLICATIONS

The following application claims benefit of U.S. Provisional Application No. 60/745,716, filed Apr. 26, 2006, which is hereby incorporated by reference in its entirety.

### STATEMENT REGARDING GOVERNMENT SPONSORED RESEARCH

Aspects of this work were supported by a grant from the Department of the Army through Grant No. DAAD19-03-1-0173; by the National Science Foundation through Grant Nos. CTS 0332315; EEC 0210835; and CTS 04041224; and with support under Contract No. DE-AC04-94AL85000 from the Department of Energy. The United States Government has certain rights in the subject matter.

### TECHNICAL FIELD

The present invention relates to bicellar mixtures. More specifically the present invention relates to methods of using mixtures of short and long chain phospholipids to form lipid bilayers suspended on solid substrates and methods of using the same.

### BACKGROUND

Phospholipids are a major component of all biological membranes. In its simplest form, a phospholipid is composed of glycerol bonded to two fatty acids and a phosphate group. Due to its polar nature, the head of a phospholipid is hydrophilic while the nonpolar tails are hydrophobic. When placed in water, phospholipids form a bilayer, composed of a hydrophobic core region formed by the acyl chains of the lipids, and hydrophilic membrane interfacial regions that are formed by the polar head groups of the lipids.

Membranes made of phospholipid bilayers are partially permeable, very flexible, and have fluid properties in which embedded proteins and phospholipid molecules are constantly moving laterally across the membrane. Proteins incorporated into the phospholipid bilayer can facilitate actions such as compartmentalization, passive and active transport, signal transduction, specific recognition, and energy utilization.

Because of their versatility in function, scientists have long sought to incorporate phospholipid bilayer membranes into artificial materials and devices. These devices have a broad range of potential applications including proteomics; membrane study; ligand based biosensors for clinical diagnostics; memory devices; screening devices for pharmaceutical applications; the provision of biologically functionalized surfaces; binding sites for small molecules such as drugs, pesticides, molecules required to be analyzed during process control (i.e. food stuffs, fermenter products, chemicals); larger molecules such as proteins for research screening (e.g. array technology) or diagnostics (cancer markers, infectious disease markers, hormones); high throughput screening for pharmaceutical applications; controlled drug delivery; medical diagnosis; environmental monitoring, chemical and biological warfare agent sequestration; actuator development; power sources; electrochemical pumps; and bio-fuel cell development.

However, phospholipid bilayer membranes are inherently fragile. Due to their thinness, polar charge, tendency to naturally curve, and the inherently weak self-assembly forces at work, they are subject to disruption from phenomenon such as vibration, sonication, chemical reaction, pH, temperature denaturing, electromagnetic fields and the like making them unsuitable for applications outside of the most stringently controlled conditions.

In an effort to increase stability, lipid bilayers have been constructed on a variety of solid supports including mica, glass or silica. However, there have been difficulties in decoupling the membrane from substrate influences which may inhibit membrane fluidity, diminishing the usefulness and functioning of supported membranes. Efforts to overcome these obstacles have included extending the distance between the single layer of the lower half of a fluid bilayer membrane and the substrate through the use of long hydrophilic spacers (Lang, H., et al., Langmuir 10:197-210 (1994)); tethering from soft polymer cushions (Sinner, E. K., et al., Curr. Opinion Chem. Biol. 5:507-711 (2001); creating undulated bilayers in porous alumina (Gaede, H. C., et al., Langmuir 20:7711-7719 (2004)); suspending lipid bilayers over micromachined holes (Ogier, S. D., et al., Langmuir 16:56996-5701 (2000)); and nanoscale pores (Hennesthal, C., et al., J. Am. Chem. Soc., 122:8085-8086 (2000)). However these structures confine the mobility of lipids and proteins to the isolated suspended areas. Additionally, fluid exchange beneath the suspended bilayer is blocked by the geometry of the resulting structures. Other efforts to create biomimetic membranes resulted in the formation of a double lipid bilayer lobe on the surface of a single lipid bilayer spreading along the bottom of microgrooves (Suzuki, K., et al., Langmuir 21:6487-6494 (2005)) which also does not mimic natural membrane structure.

There is therefore a need for the creation of stable membranes which preserve the fluidity of lipids and proteins in a membrane as well as permit fluid exchange beneath the suspended bilayer, mimicking natural biological processes.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows confocal microscopy images of a supported lipid bilayer prepared with a 2.8:1 DPPC (with 0.1 mol % BODIPY-PE):DHPC (with 0.5% TRITC-DHPE) bicellar mixture on a flat silicon substrate taken using (A) Rhodamine fluorescence, (B) dipyrromethene boron difluoride (BODIPY) fluorescence and (C) a superimposition of A and B.

FIG. 2 (A) is a tapping mode atomic force microscopy (AFM) image of a supported lipid bilayer prepared with a 2.8:1 DPPC (with 0.1 mol % BODIPY-PE):DHPC (with 0.5% TRITC-DHPE) bicellar mixture on a flat silicon substrate showing regions rich in DPPC (black arrow) and DHPC (green arrow).

FIG. 2 (B) is a topographic profile of the lipid bilayer of FIG. 2 (A) along the dashed line of FIG. 2A showing a bilayer height of 58.5 Å (blue arrows in FIGS. 2A and 2B) and a DHPC-DPPC height difference of 14 Å (pink arrows FIGS. 2A and 2B) (Scale bar=1 μm) which corresponds to the difference in the chain lengths of DHPC (7 carbon chain) and DPPC (16 carbon chain).

FIG. 3 (A) shows an image of a nanotextured or nanostructured silicon wafer typical of wafers used in this study taken using SEM revealing a channel depth of 380 nm, a channel width of 175 nm and a ridge width of 300 nm.

FIG. 3 (B) shows an image of the nanotextured or nanostructured silicon wafer of FIG. 3 (A) taken using Tapping mode AFM (scale bar=375 nm).

FIG. 3(C) shows section analysis of the silicon wafer of FIGS. 3(A) and 3(B) along the dashed line in FIG. 3B showing a topographic profile of the nanotextured silicon wafer having a channel depth of about 9.1 nm (blue arrows in FIGS. 3B and 3C) and a width of about 170 nm (pink arrows in FIGS. 3B and 3C).

FIG. 4(A) shows confocal microscopy images of a supported lipid bilayer prepared with a 2.8:1 DPPC (with 0.1 mol % BODIPY-PE):DHPC (with 0.5% TRITC-DHPE) bicellar mixture on a nanotextured silicon substrate taken using Rhodamine fluorescence.

FIG. 4(B) shows confocal microscopy images of the supported lipid bilayer of FIG. 4(A) taken using dipyrromethene boron difluoride (BODIPY) fluorescence.

FIG. 4 (C) is a superimposition of FIGS. 4A and 4B.

FIG. 5(A) shows an image taken using tapping mode atomic force microscopy (AFM) of a supported lipid bilayer prepared with a 2.8:1 DPPC (with 0.1 mol % BODIPY-PE):DHPC (with 0.5% TRITC-DHPE) bicellar mixture on a nanotextured silicon substrate (scale bar=375 nm).

FIG. 5(B) shows a topographic profile of the lipid bilayer of FIG. 5(A) along the dashed line of FIG. 5A showing the depth in the center of the channel of 42.9 nm (blue arrows in FIGS. 5A and 5B).

FIG. 6 is a tapping mode AFM image of a lipid bilayer containing areas rich in DPPC (blue arrow) and DHPC (pink arrow) on a nanotexured silicon substrate. A hole in the lipid bilayer is indicated by the light blue arrow (Scan size=750 nm, Scale bar=175 nm)

FIG. 7(A) depicts a 3-D representation of the AFM image of a nanotextured silicon substrate before applying the bicellar mixture. (Scan size=1.5 μm)

FIG. 7(B) depicts a 3-D representation of the nanotextured silicon substrate of FIG. 7(A) after application of a 2.8:1 DPPC:DHPC bicellar mixture. (Scan size=1.5 μm).

FIG. 8(A) depicts the structure of DHPC.

FIG. 8(B) depicts the structure of DPPC.

FIG. 9 is a schematic representation of the formation of a supported lipid bilayer on a solid surface.

### DETAILED DESCRIPTION

The present invention provides methods for preparing biometric lipid bilayers which are both suspended and supported by solid substrates allowing for rapid fluid exchange under the suspended portions of the bilayers.

The present invention additionally provides lipid bilayer assemblies with an open membrane architecture which permits mobility of lipids, thus permitting free access to multiple membrane components and improved activity in incorporated proteins. In some embodiments, such bilayer assemblies may be magnetically oriented.

The lipid bilayers of the present invention may be used in a variety of applications including, but not limited to, proteomics, the study of membrane proteins, biosensing modeling studies, intracellular signaling, receptor-ligand binding, preparation of model membrane mimics, formation of electrophoretic or chromatographic media, Brownian ratchet devices for separating charged phospholipids, the study of cellular interactions, biosensing, medical diagnosis, environmental monitoring, chemical and biological warfare agent detection and sequestration, actuator development, power sources, sensing platforms, electrochemical pumps, and bio-fuel cell development.

Phospholipid bilayer membranes are essential components of cellular systems. They enable a variety of functions including compartmentalization, passive and active transport, signal transduction, specific recognition and energy utilization.

Previous studies using lipid vesicles to form supported lipid bilayers on flat supports found slow formation of supported lipid bilayers when performed at a temperature close to or below the transition temperature (Tₘ) of single or mixed long-chain phosphocholine lipids. (Seantier, B., et al., NanoLetters, 4:5-10 (2004) and Beckmann, M., et al., Member. Biol. 161:227-233 (1998)). This was found to be a result of slower vesicle rupture, but not vesicle adsorption to the support. Embodiments of the present invention use planar lipid assemblies instead of vesicles. There is therefore no need for post processing of the bilayer structure.

It is theorized that by eliminating the slow step of vesicle rupturing at low temperatures for vesicle fusion through the use of planar bicellar assemblies, the dependence of supported lipid bilayer formation on the temperature of the surrounding environment may be reduced.

The lipid bilayer assemblies formed by the methods herein are artificial assemblies comprising a bicellar mixture of long and short chain phospholipids which may additionally incorporate biomolecules. The lipid bilayer assemblies are suspended on a solid support such that liquid can flow over and under the lipid bilayer. The suspended lipid bilayer may additionally allow increased access to and improved activity in incorporated proteins.

Bilayered micelles, or “bicelles” are planar, bilayered aggregates that form in aqueous solution from mixtures of long- and short-chain phospholipids. It is believed that the function of the short-chain molecules is to coat the edges of the bilayered sections to protect the longer phospholipid chains from exposure to water, serving the same role as bile salts do upon digestion of phospholipid membranes in vivo. This phase exhibits nematic discotic order and is stable over a wide range of lipid concentration (typically 3-40% w/v), temperature (30-45° C.), ionic strength, and pH.

The lipid bicellar mixtures of the present invention are prepared by combining mixtures of short chain phospholipids (6-8 carbon chain length) and long chain phospholipids (≧14 carbon chain length). Such bicellar mixtures can form multiple morphological lipid assemblies in aqueous suspensions including, but not limited to, planar lipid assemblies such as bicelles, long ribbon-like micelles, quasi-cylindrical micelles, and branched flattened cylindrical micelles. Exemplary phospholipids for use within the compositions and methods of the present invention include, but are not limited to, 1,2-dipalmitoyl-sn-glycero-3-phosphocholine (DPPC); 1,2-diheptanoyl-sn-glycero-3-phosphocholine (DHPC); 1,2-dihexanoyl-sn-glycero-3-phosphoethanolamine (DHPE), 1,2-dimyristoyl-sn-glycero-3-phosphocholine (DMPC); 1,2-DiODodecyl-sn-Glycero-3-Phosphocholine (DIODPC); 3-(ChlorAmidoPropyl)-dimethylammonio2-Hydroxy-1-Propane Sulfonate (CHAPSO); dimyristoyl phophatidylserine (DMPS); dimyristoyl phosphatidylglycerol; dilauryl phosphatidycholine (DLPC); 1,2-dimyristoyl-sn-glycero-3-phosphoethanolamine (DMPE; 14:0); 1,2-dimyristoyl-sn-glycero-3-[phospho-rac-(1-glycerol)] (Sodium Salt) (DMPG, 14:0); 1-myristoyl-2-hydroxy-sn-glycero-3-phosphocholine (14:0 Lyso PC); 1-oleoyl-2-hydroxy-sn-glycero-3-phosphoethanolamine (18:1 Lyso PE); L-phosphatidylcholine (Egg, Soy); phosphatidylcholine (NBD); 1,1′,2,2′-tetramyristoyl cardiolipin (Ammonium Salt) (14:0); lipids with head groups phosphatidyl serine and phosphatidylinositol; poly(ethylene glycol)-lipid conjugates; and fluorescent lipids-phosphatidylcholine (NBD); 1,2-didecanoyl-sn-glycero-3-phosphocholine (DDPC); 1,2-dierucoyl-sn-glycero-3-phosphate (sodium salt) (DEPA-NA); 1,2-erucoyl-sn-glycero-3-phosphocholine (DEPC); 1,2-dierucoyl-sn-glycero-3-phosphoethanolamine (DEPE); 1,2-linoleoyl-sn-glycero-3-phosphocholine (DLOPC); 1,2-dilauroyl-sn-glycero-3-phosphate (sodium salt) (DLPA-NA); 1,2-dilauroyl-sn-glycero-3-phosphoethanolamine (DLPE); 1,2-dilauroyl-sn-glycero-3-phosphoserine (sodium salt) (DLPS-NA); 1,2-dimyristoyl-sn-glycero-3-phosphate (sodium salt) (DMPA-NA); 1,2-dimyristoyl-sn-glycero-3-phosphoserine (sodium salt) (DMPS-NA); 1,2-dioleoyl-sn-glycero-3-phosphate (sodium salt) (DOPA-NA); 1,2-oleoyl-sn-glycero-3-phosphocholine (DOPC), 1,2-dioleoyl-sn-glycero-3-phosphoethanolamine (DOPE); 1,2-dioleoyl-sn-glycero-3-phosphoserine (sodium salt) (DOPS-NA); 1,2-dipalmitoyl-sn-glycero-3-phosphate (sodium salt) (DPPA-NA); 1,2-dipalmitoyl-sn-glycero-3-phosphoethanolamine (DPPE); 1,2-dipalmitoyl-sn-glycero-3-phosphoserine (sodium salt) (DPPS-NA); 1,2-distearoyl-sn-glycero-3-phosphate (sodium salt) (DSPA-NA); 1,2-distearoyl-sn-glycero-3-phosphocholine (DSPC); 1,2-diostearpyl-sn-glycero-3-phosphoethanolamine (DSPE); 1,2-distearoyl-sn-glycero-3-phosphoserine (sodium salt) (DSPS-NA); 1-myristoyl, 2-stearoyl-sn-glycero 3-phosphocholine (MSPC); 1-palmitoyl, 2-myristoyl-sn-glycero 3-phosphocholine (PMPC); 1-palmitoyl, 2-oleoyl-sn-glycero 3-phosphocholine (POPC); 1-palmitoyl-2-oleoyl-sn-glycero-3-phosphoethanolamine (POPE); 1-palmitoyl, 2-stearoyl-sn-glycero 3-phosphocholine (PSPC); 1-stearoyl, 2-myristoyl-sn-glycero 3-phosphocholine (SMPC); 1-stearoyl, 2-palmitoyl-sn-glycero 3-phosphocholine (SOPC); 1-stearoyl, 2-palmitoyl-sn-glycero 3-phosphocholine (SPPC); or combinations thereof. The lipid bicellar mixtures for use in the present invention may include one or more short chain phospholipids and one or more long chain phospholipids. For example, a bicellar mixture may comprise 1,2-dipalmitoyl-sn-glycero-3-phosphocholine (DPPC) and 1,2-diheptanoyl-sn-glycero-3-phosphocholine (DHPC). In another embodiment, an exemplary bicellar mixture may comprise 1,2-dihexanoyl-sn-glycero-3-phosphoethanolamine (DHPE) and 1,2-dimyristoyl-sn-glycero-3-phosphocholine (DMPC). In a further embodiment, an exemplary bicellar mixture may comprise 1,2-DiODodecyl-sn-Glycero-3-Phosphocholine (DIODPC), and 3-(ChlorAmidoPropyl)-dimethylammonio2-Hydroxy-1-Propane Sulfonate (CHAPSO). Other embodiments may contain alternate combinations of one or more short and long chain phospholipids.

The resulting structural form and size of the lipid assemblies of the present invention may be controlled by a number of factors including, but not limited to, pH, surfactant choice, solvent choice, temperature, the molar ratio of long-chain to short-chain phospholipids (q ratio), and the lipid weight fraction in suspension (C_{L}). For example, between the values of 0.5≦q≦4 and 1%≦C_{L}≦40%, as either the temperature or the q ratio increases, increasingly larger planar bilayer assemblies form in the following order: bicelles, long ribbon-like micelles, and branched flattened cylindrical micelles. At higher temperatures or q ratios, more complex non-planar assemblies form including perforated lamellar sheets and multilamellar vesicles. In some embodiments of the present invention, the molar ratio of long chain to short chain phospholipids is about 0.3 to about 5.0, preferably about 1.0 to about 4.0, preferably about 2.0 to about 3.3, more preferably about 1 to about 2.8. In other embodiments of the invention, the bicellar mixtures form a planar lipid bilayer structure.

Short-chain phospholipids may solubilize membrane proteins. The inclusion of short chain phospholipids in the compositions of the present invention may therefore be useful for the incorporation of biomolecules such as membrane proteins into the lipid assemblies without having to isolate the membrane proteins. The inclusion of biomolecules such as membrane proteins may be useful for a variety of purposes including, but not limited to, in proteomics, studying membrane function, and using the suspended lipid bilayers as an eletrophoretic or chromatographic media.

Exemplary biomolecules that may be used in the methods of and compositions of the present invention may include, but are not limited to, peptides, polypeptides, proteins, ion channels, receptors, ligands for receptors, antigens, antibodies, oligonucleotides, nucleotides, polynucleotides, aptamer, DNA, RNA, carbohydrate or a mixture or complex thereof. For example, biomolecules may include protein coupled receptors including, but not limited to, Class A (Rhodopsin-like) G protein coupled receptors which bind amines, peptides, hormone proteins, rhodopsin, olfactory prostanoid, nucleotide-like compounds, cannabinoids, platelet activating factor, gonadotropin-releasing hormone, thyrotropin-releasing hormone and secretagogue, melatonin and lysosphingolipid and LPA; G protein coupled receptors with amine ligands including, but not limited to, acetylcholine or muscarinic, adrenoceptors, dopamine, histamine, serotonin or octopamine receptors; peptide ligands including, but not limited to, angiotensin, bombesin, bradykinin, anaphylatoxin, Fmet-leu-phe, interleukin-8, chemokine, cholecystokinin, endothelin, melanocortin, neuropeptide Y, neurotensin, opioid, somatostatin, tachykinin, thrombin vasopressin-like, galanin, proteinase activated, orexin and neuropeptide FF, adrenomedullin (G10D), GPR37/endothelin B-like, chemokine receptor-like and neuromedin U; hormone protein, rhodopsin, olfactory, prostanoid, nucleotide-like (adenosine, purinoceptors), cannabinoid, platelet activating factor, gonadotropin-releasing hormone, thyrotropin-releasing hormone and secretagogue, melatonin, lysosphingolipid, and LPA; Class B secretin-like g protein coupled receptors including, but not limited to, those which bind calcitonin, corticotropin releasing factor, gastric inhibitory peptide, glucagon, growth hormone-releasing hormone, parathyroid hormone, PACAP, secretin, vasoactive intestinal polypeptide, diuretic hormone, EMR1 and latrophilinl; class C metabotropic glutamate receptors including, but not limited to, those which bind metabotropic glutamate, extracellular calcium-sensing or GABA-B; receptor kinases; ion channels including, ionophores such as gramicidin, almaethicin, valinomycin, amphotericin B, and colcins; ligand gated channels such as acetylcholine receptor, glycine and GABA receptor, cytochrome oxidase, seratonin receptor, and IgE receptors; voltage gated channels such as, Na+ ion channel, K+ ion channel, chloride channel, and Ca2+ ion channel; light gated channels such as rhodopsin, and channelopsin1; active transport systems including, but not limited to, bacteriorhodopsin, Ca²⁺-ATPase, Na⁺/K⁺ ATPase, Na⁺-Glucose cotransport (Secondary), and H⁺/K⁺ ATPase ABC Transporters; porins, including alpha-hemolysin; and toxins such as diptheria and cholera toxins. Such biomolecules may be incorporated in the lipid assemblies during the formation of the bicellar mixtures, during formation of the membrane, through self-directed insertion into the membrane, or any combination thereof.

The resulting bicellar or bicellar/biomolecular mixtures of the present invention may be coated onto a variety of structured supports including, but not limited to, silica, mica, glass, aluminum, oxidized silicon, semiconductor chips, biochips, nanotextured surfaces, nanostructured surfaces, silicon wafer, silane-silicon, self assembled monolayer-gold, SnO₂, polymer coated substrates, gold, gold-SAM, porous alumina or any combination thereof. In some embodiments, the support has a nanotextured surface. Such a nanotextured surface may have troughs, holes, wells, channels, pores, or a combination thereof. Such features may provide a means for rapid fluid exchange under the suspended portion of the bilayer through the introduction or removal of fluid through the troughs, holes, wells, channels, pores, or combinations thereof of the support.

The troughs, holes, wells, channels, pores, or combinations thereof of the support may be arranged in a regular array or in an asymmetric manner. In some embodiments, the features may be of different sizes. In other embodiments, the features may be of uniform size. In one embodiment, the nanotextured surface comprises a series of parallel troughs. Such troughs may have homogenous or varied widths. In one embodiment, widths of the troughs may vary from about 10 nm to about 600 nm, preferably from about 100 nm to about 500 nm, more preferably from about 100 nm to about 300 nm, more preferably from about 100 nm to about 175 nm, more preferably from about 100 nm to about 170 nm wide. Such troughs may additionally have homogenous or varied depths. Depths of troughs may vary from about 10 nm to about 600 nm, more preferably from about 90 nm to about 500 nm, more preferably from about 100 nm to about 500 nm, more preferably from about 250 nm to about 500 nm, more preferably from about 300 nm to about 400 nm, more preferably from about 300 nm to about 380 nm. In additional embodiments, the spacing between the troughs may be uniform or varied. The troughs may be from about 10 nm to about 600 nm apart, more preferably from about 100 nm to about 500 nm apart, more preferably from about 250 nm to about 425 nm apart, more preferably from about 300 nm to about 350 nm apart. In some embodiments, the solid support is a nanotextured silicon wafer.

Coating may be accomplished by any means applicable. In some embodiments, the solution is spin coated. In other embodiments, the solution is dip coated. In further embodiments, the solution may be deposited on a solid support using a combination of spin and dip coating. In some embodiments, the bicellar mixture may be transferred to a solid support by placing the solid support on top of a portion of the lipid mixture for a period of time and then rinsing the resulting assembly. In other embodiments, the resulting lipid assembly may have an aqueous layer between the phospholipid membrane and the solid support. Such an aqueous layer may be between about 1 nm to about 5 nm in thickness.

While not wishing to be bound, the large diameter of the planar bicellar assemblies of the present invention (preferably between about 0.75 to 10 μm, more preferably about 0.75 to about 1 μm, more preferably about 0.75 to about 0.95 μm, more preferably about 0.75 to about 9 μm, more preferably about 5 to about 8 μm) are believed to facilitate the formation of supported lipid bilayers without the application of high force loads which were required in previous studies to adsorb a lipid bilayer to mica so that they remained intact as a monolayer on discs of the mica. (Bayburt, T. H., et al., NanoLetters, 2, 853-856 (2002))

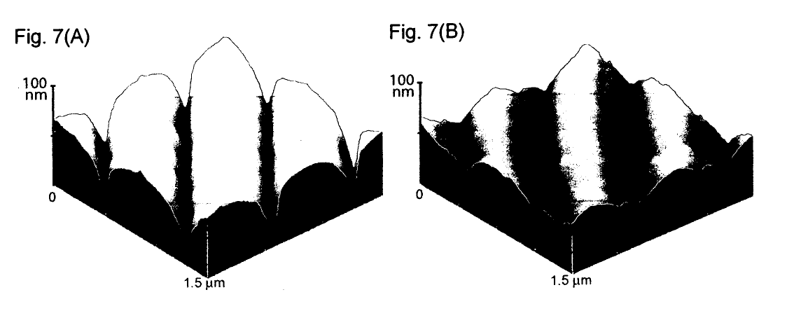

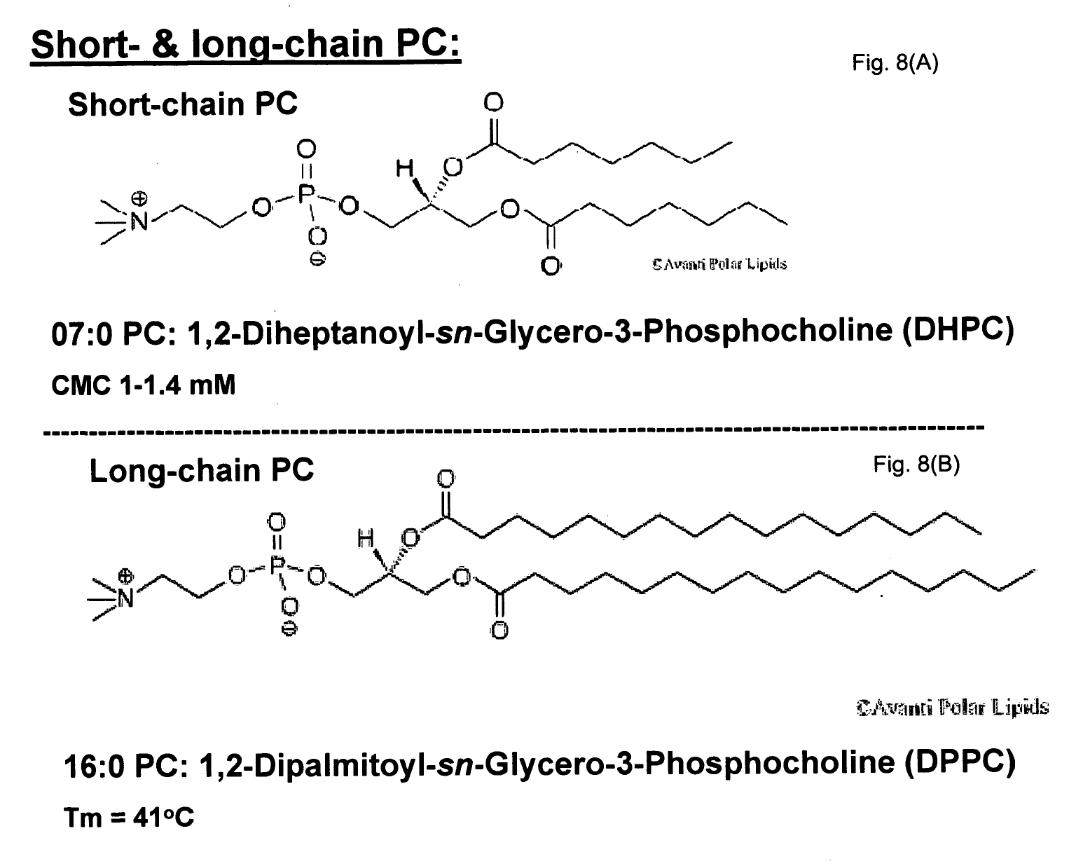

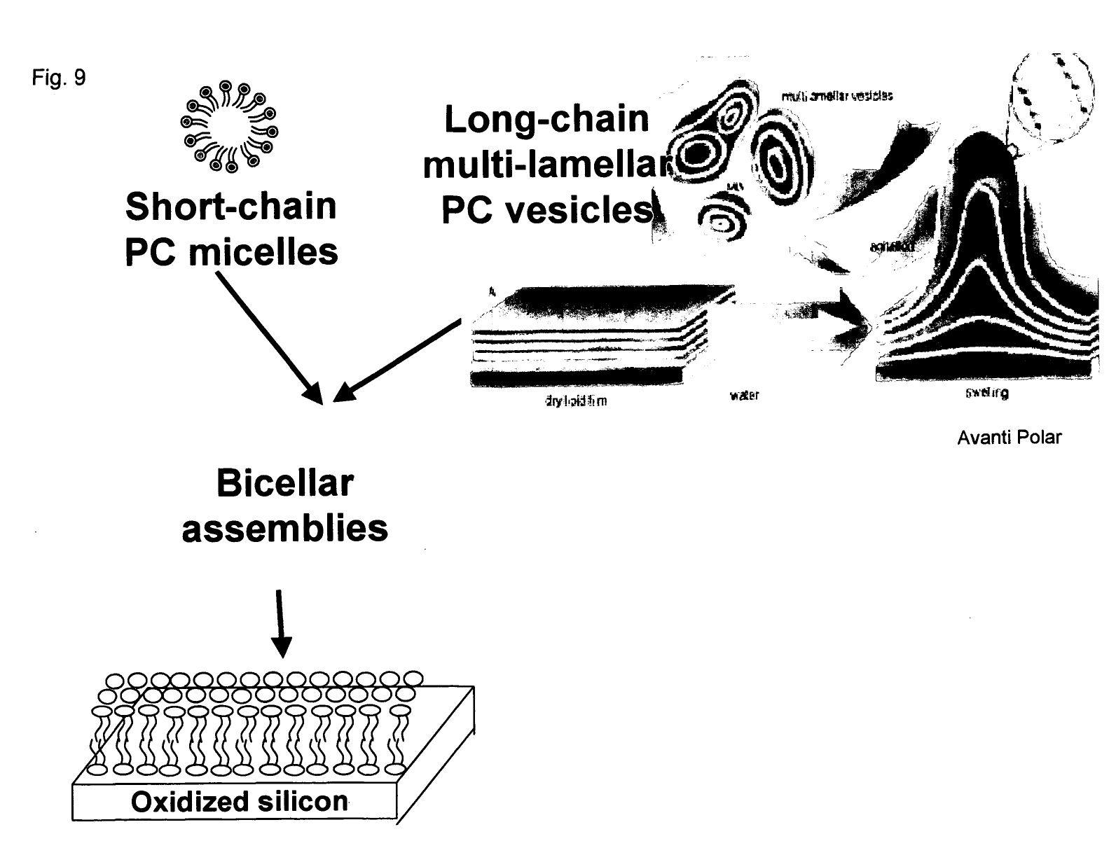

The formation of the suspended lipid membranes of the present invention on solid supports may be determined by any means applicable. In some embodiments, such determinations may be made using confocal microscopy. In further embodiments, such determinations may be made using atomic force microscopy. Such images may be converted to 3D representations for ease of viewing and analysis. For example, FIG. 7 shows 3D representations of the AFM images of the uncoated and bilayer coated nanochannel structures. It is evident in FIG. 7 that a relatively smooth and continuous bilayer was supported and suspended across the structure. The undulations have radii of curvature of ˜175 nm in both the crests and troughs of the supported and suspended areas, respectively.

The functioning of the incorporated proteins may be determined by any means applicable. For example, changes in hydrogen ion flux such as with the incorporation of gramicidin may be determined by impedence analysis. Ion sensitive fluorescent dies may be used to track gradients in ionic concentration. Electrophoretic mobility of ions through the hybrid membranes may also be characterized. Theoretical models of membrane transport may be used to calculate diffusion constants of ions, thus allowing quantitative comparisons between different membrane formulations. Additionally, membrane permeability in complex aqueous environments may also be determined. In a further embodiment, light induced pH changes caused by the proton pumping action of light activated proteins such as bacteriorhodobsin may be measured using pH meters and pH sensitive fluorescent dyes such as SNAFL-2 or fluorescein.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims.

As used herein and in the appended claims, the singular forms “a,” “an,” and “the” include plural reference unless the context clearly dictates otherwise. Thus, for example, a reference to “a host cell” includes a plurality (for example, a culture or population) of such host cells, and so forth.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

The following examples illustrate certain embodiments of the present invention, and are not to be construed as limiting the present disclosure. The evidence provided in these examples demonstrates the feasibility of using bicellar assemblies to form suspended single lipid bilayers on nanochannel architectures.

### EXAMPLE I

### Preparation of Nanotexured Silicon Wafers

Silicon wafers were cleaved into 3×4 cm chips. The chips were cleaned in piranha solution (1 part H₂O₂: 2 parts H₂SO₄ by volume) and then rinsed three times in deionized water. The chips were then dipped in HF acid and again rinsed three times in deionized water. A 150 nm thick layer of XHRiC-16 (Brewer Science, Inc., Rolla, Mo.) antireflective coating was then spin deposited on the chips at 400 rpm for 30 s. The samples were then hard baked at 175° C. for 3 min. A 200 nm layer of positive photoresist (SPR510a photoresist diluted by an equal amount of EC-11 solvent (Shipley Company, L.L.C., a division of Rohm and Haas Electronic Materials, Marlborough, Mass.)) was then spin coated at 4000 rpm for 30 s onto the resulting chip which was then soft baked at 95° C. for 3 minutes.

The resulting chip was then exposed to the frequency-tripled (k=355 nm) output of a YAG-Nd laser (Infinity 40-100, Coherent, Inc., Santa Clara, Calif.). After exposure, each chip was soft baked at 110° C. for 1 minute and then developed using undiluted MF702 developer (Shipley Company, L.L.C.) and rinsed with water. The developed chip was placed in an e-beam evaporator and a thin (35-40 nm) layer of Cr was deposited. The remaining photoresist with the Cr on top of it was then removed using an airbrush acetone spray leaving a negative-tone Cr etch mask layer on top of the remaining antireflective coating.

The samples were then reactive ion etched using a mixture of O₂ and CHF₃. The etched silicon gratings were cleaned with piranha solution to remove the anti reflective coating, Cr and residual polymer from the reactive ion etching process. After cleaning, the chips were placed in a quartz tube furnace containing ultrahigh-purity grade O₂ at 1100° C. for 45-60 minutes to form an insulating oxide layer. (O'Brien, M. J et al. J. Vacuum Sci. Tech. B 2003, 21: 2941-2945) Additional steps, if desired, may be found, for example, in O'Brien et al., which is hereby incorporated by reference in its entirety.

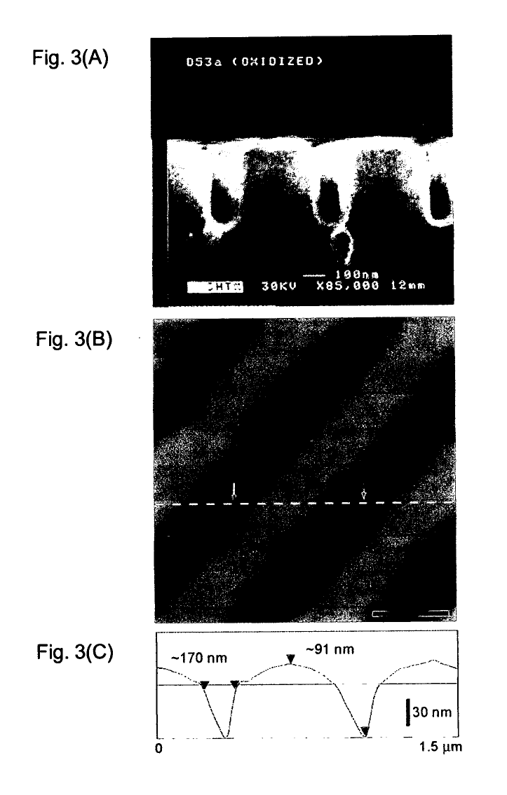

The channels in the resulting wafers had a tapered structure with the width at the top of the channels of ˜175 nm and a width of ˜100 nm at the bottom and with a depth of ˜380 nm as seen in FIG. 3A. The ridges had a width of ˜300 nm. The width of the channel was confirmed by tapping mode AFM as seen in FIG. 3B. However, the size of the imaging tip prevented an accurate measurement of the channel depth and tapered structure. A maximum dept of ˜100 nm was attained by AFM. Section analysis as seen in FIG. 3C shows a topographic profile with a channel depth of about 9.1 nm and width of about 170 nm.

### EXAMPLE II

### Preparation of Multi-Lamellar Vesicle Solution of Long Chain Phosphocholine

A multi-lamellar vesicle solution of long chain phosphocholine in 75 mM phosphate buffer, pH 7.0 was prepared at 63° C. from a 72 mM 1,2-dipalmitoyl-sn-glycero-3-phosphocholine (DPPC) (Avanti Polar Lipids, Inc. (Alabaster, Ala.) solution in chloroform containing 0.5 mole % N-(6-tetramethylrhodaminethiocarbamoyl)-1,2-dihexadecanoyl-sn-glycero-3-phosphoethanolamine, triethylammonium salt (TRITC-DHPE) (Invitrogen-Molecular Probes (Carlsbad, Calif.)). The chloroform was removed from the 72 mM 1,2-dipalmitoyl-sn-glycero-3-phosphocholine (DPPC) solution prior to use by drying using nitrogen gas followed by vacuum for ten minutes.

### EXAMPLE III

### Preparation of Micellar Solution of Short Chain Phosphocholine

A micellar solution of short-chain phosphocholine in 75 mM phosphate buffer, pH 7.0 was prepared at room temperature from a 104 mM solution in chloroform of 1,2-diheptanoyl-sn-glycero-3-phosphocholine (DHPC) (Avanti Polar Lipids, Inc. (Alabaster, Ala.)) containing 0.1 mole % of phosphoethanolamine labeled with dipyrromethene boron difluoride (PE-BODIPY, N-(4,4-difluoro-5,7-dimethyl-4-bora-3a,4a-diaza-s-indacene-3-propionyl)-1,2-dihexanoyl-sn-glycero-3-phosphoethanolamine, triethylammonium salt. (Invitrogen-Molecular Probes (Casrlsbad, Calif.)). The chloroform was removed from the 1,2-diheptanoyl-sn-glycero-3-phosphocholine (DHPC) solution prior to use by drying using nitrogen gas followed by vacuum for ten minutes

### EXAMPLE IV

### Preparation of Bicellar Mixtures

The multi-lamellar vesicle solution of long chain phosphocholine in 75 mM phosphate buffer, pH 7.0 from Example II was combined at room temperature with the micellar solution of short-chain phosphocholine in 75 mM phosphate buffer, pH 7.0 of Example III, while mixing to yield final concentrations of 10 mM and 28 mM respectively. The resulting solution had a C_{L} of 2.5 wt % and a q ratio of 2.8. The mixture was then hydrated by storing at 4° C. for 19-24 hours before use.

Dynamic light scattering measurements using a Microtrac-S3000 laser particle size analyzer (Microtrac, Inc., (North Largo, Fla.)) indicated that the bicellar assemblies consisted of two populations with average lengths of 750±250 nm and 5±3 μm respectively.

### EXAMPLE V

### Formation of Lipid Bilayers Using Bicellar Mixtures

Nanotextured wafers of Example I or thermally oxidized flat silicon wafer (NOVA Electronic materials, Ltd. (Carrollton, Tex.)) were prepared by cleaning with a quick dip in piranha solution (1 part of 30% H₂O₂, 2 parts H₂SO₄ by volume) followed by a rinsing with ultrapure water. A 40 μL drop of the lipid suspension of Example IV was placed in a glass Petri dish. A cleaned wafer was placed on the lipid suspension for 10 minutes. The Petri dish was then filled with ultrapure water and the assembly rinsed by submerging in a larger crystallization dish filed with ultrapure water with gentle shaking, and repeating two more times.

### EXAMPLE VI

### Examination of Bicellar Mixtures on a Flat Substrate

Supported lipid bilayers were prepared on thermally oxidized flat silicon wafers (NOVA Electronic Materials, Ltd. (Carrollton, Tex.)) as described in Example V. The resulting assemblies were inverted while submerged and transferred into a 2 cm×2 cm square container containing ultrapure water. A cover slip was placed on top of the wafer tand the excess water was removed. Confocal images were generated using a Zeiss LSM 510 confocal microscope (Carl Zeiss MicroImaging, Inc., (Thornwood, N.Y.)), with excitation at 488 nm using Argon laser and at 543 nm using Helium Neon 1.

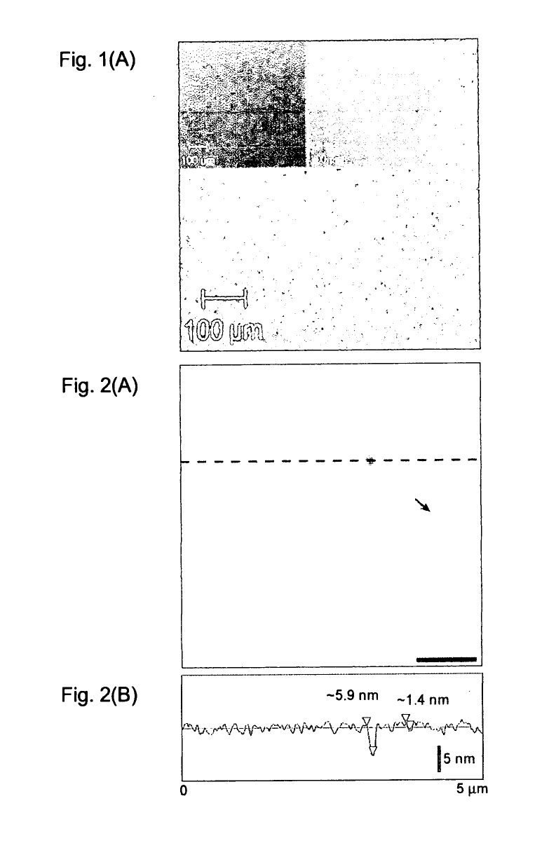

As can be seen in FIG. 1, the lipid bilayer covering the flat substrate was homogenous with homogenous distribution of fluorescence from both the long (TRITC labeled) and short (BODIPY labeled) lipids.

The supported bilayer assemblies were further examined using atomic force microscopy (AFM). A silicon wafer sample was transferred to the AFM liquid cell by placing the O-ring of the liquid cell on the sample while under water. The O-ring was then clamped to the sample using tweezers and carefully removed from the water so that the sample surface remained submerged. The bottom of the sample was carefully dried with a towel, and the sample was attached to an AFM puck on the scanner with double-sided tape. The liquid cell was then quickly assembled and filled with deionized water. AFM imaging of the supported lipid bilayer was then performed with a Nanoscope IIIa Multimode (Digital Instruments (Santa Barbara, Calif.)), with images acquired in solution with tapping mode using a commercially available liquid cell (Digital Instruments). Images were collected with the E-scanner operating at a scan rate of 2 HZ using 120 μm oxide-sharpened silicon nitride V-shaped cantilever shaving a nominal spring constant of 0.35 N/m.

As can be seen in FIG. 2, images of the 2.8:1 DPPC/DHPC bilayer on flat silicon wafers revealed a continuous lipid bilayer composed of two phases. The black arrow in FIG. 2 points to a region rich in DPPC, while the green arrow points to a region rich in DHPC. The height difference between the DPPC and DHPC areas was measured to be ˜14 Å, which corresponds to the difference between the chain lengths of DHPC (7 carbon-chain) and DPPC (16 carbon-chain). The phase separation was due to immiscibility of the two phases stemming from the preferential interactions between the acyl chains of similar length in the fluid (DHPC) in contrast to the gel phase (DPPC).

### EXAMPLE VII

### Examination of Bicellar Lipid Bilayers on Nanotexured Substrate

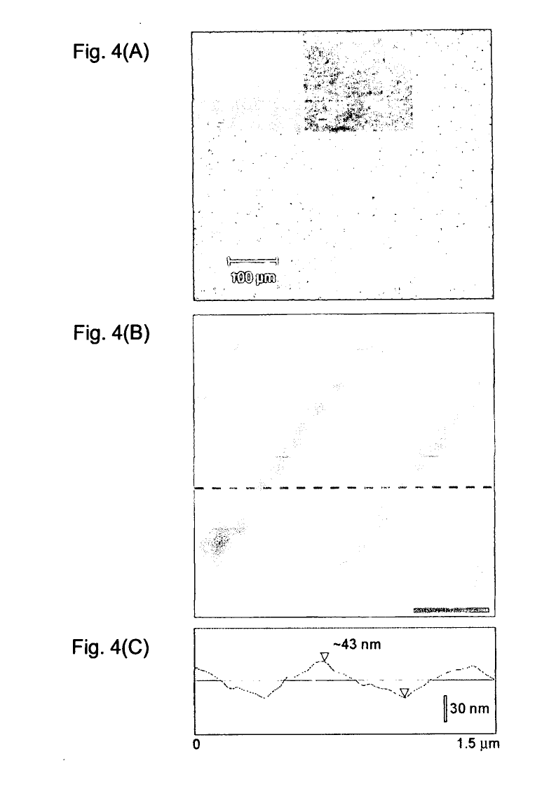

Supported lipid bilayers were prepared on nanotextured silicon wafers as described in Example V. The resulting assemblies were inverted while submerged and transferred into a 2 cm×2 cm square container containing ultrapure water. A cover slip was placed on top of the wafer tand the excess water was removed. Confocal images were generated using a Zeiss LSM 510 confocal microscope (Carl Zeiss MicroImaging, Inc., (Thornwood, N.Y.)), with excitation at 488 nm using Argon laser and at 543 nm using Helium Neon 1. As can be seen in FIG. 4A, the long and short chain lipids were homogeneously distributed over the surface.

The supported bilayer assemblies were further examined using atomic force microscopy (AFM). A silicon wafer sample was transferred to the AFM liquid cell by placing the O-ring of the liquid cell on the sample while under water. The O-ring was then clamped to the sample using tweezers and carefully removed from the water so that the sample surface remained submerged. The bottom of the sample was carefully dried with a towel, and the sample was attached to an AFM puck on the scanner with double-sided tape. The liquid cell was then quickly assembled and filled with deionized water. AFM imaging of the supported lipid bilayer was then performed with a Nanoscope IIIa Multimode (Digital Instruments (Santa Barbara, Calif.)), with images acquired in solution with tapping mode using a commercially available liquid cell (Digital Instruments). Images were collected with the E-scanner operating at a scan rate of 2 HZ using 120 μm oxide-sharpened silicon nitride V-shaped cantilever shaving a nominal spring constant of 0.35 N/m.

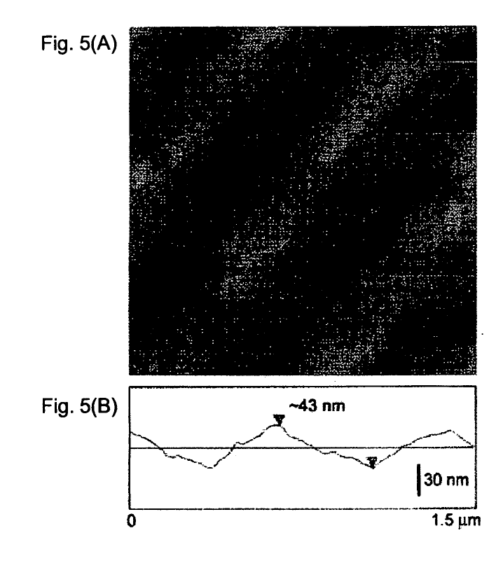

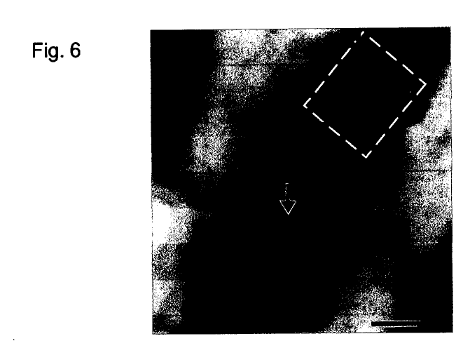

AFM imaging confirmed that the nanotexured silicon wafer was coated with the lipid bilayer, as seen in FIG. 5, covering the tops of the ridges as a single bilayer and suspending across the channels. The bilayer's topology was found to undulate with the same periodicity as the bilayer absent wafer, but with more shallow trough of 143 nm within the channel regions. Bilayer structural features were difficult to discern from the areas on the ridge tops due to the surface's inherent roughness as seen in FIG. 3B. However, the suspended regions provided areas removed from surface effects, permitting detailed examination of the bilayer. For example, within the dotted line box of FIG. 6, the dark blue arrow points to an area that is consistent with a feature rich in DPPC, while the pink arrow points to a region rich in DHPC based on height and surface area coverage. A hole in the lipid bilayer within the channel was also detected by AFM (light blue arrow in center of FIG. 6) (Scan size=750 nm, Scale bar=175 nm). While a height measurement cannot be taken from the bilayer suspended above the channel, the presence of a single bilayer on the flat silicon chip (FIG. 2) indicates that a single bilayer covers the channels. Partial multilayers were not observed on either the flat or corrugated silicon substrates.

Although the foregoing invention has been described in detail by way of example for purposes of clarity of understanding, it will be apparent to the artisan that certain changes and modifications may be practiced within the scope of the appended claims which are presented by way of illustration not limitation. In this context it will be understood that this invention is not limited to the particular formulations, process steps, and materials disclosed herein as such formulations, process steps, and materials may vary somewhat. It will also be understood that the terminology employed herein is used for the purpose of describing particular embodiments only, and is not intended to be limiting since the scope of the present invention will be limited only by the appended claims and equivalents thereof. It is further noted that various publications and other reference information have been cited within the foregoing disclosure for economy of description. Each of these references are incorporated herein by reference in its entirety for all purposes. It is noted, however, that the various publications discussed herein are incorporated solely for their disclosure prior to the filing date of the present application, and the inventors reserve the right to antedate such disclosure by virtue of prior invention.

### REFERENCES

1. Sackmann, E. Science 1996, 271: 43-48.
2. Groves, J. T.; Boxer, S. G. Acc. Chem. Res. 2002, 35:149-157.
3. Groves, J. T.; Dustin, M. L. J. Immunol. Meth. 2003, 278: 19-32.
4. Anrather, D.; Smetazko, M.; Saba, M.; Alguel, Y.; Schalkhammer, T. J. Nanosci. Nanotech. 2004, 4:1-22.
5. Cooper, M A. J. Mol. Recogn. 2004, 17:286-315.
6. Bayer, T. M.; Bloom, M. Biophys. J. 1990, 58:357-362.
7. Koenig, B. W.; Krueger, S.; Orts, W. J.; Majkrazk, C. F. Berk, N. F.; Silverton, J. V.; Gawrisch, K. Langmuir, 12 (5), 1343-1350, 1996.
8. Cremer, P. S.; Yang, T. J. Am. Chem. Soc. 1999, 121: 8131-8131.
9. Nissen, J.; Jacobs, K.; Radler, J. O. Physical. Rev. Lett. 2001, 86: 1904-1907.
10. Yang, T.; Jung, S.-Y.; Mao, H.; Cremer, P. S. Anal. Chem. 2001, 73: 165-169.
11. van Oudenaarden, A.; Boxer, S. G. Science 1999, 285:1046-1048.
12. Marchal, D.; Boireau, W.; Laval, J. M.; Moiroux, J.; Bourdillon, C. Biophys. J. 1998, 74:1937-1948.
13. Lang, H.; Duschl, C.; Vogel, H. Langmuir 1994, 10:197-210.
14. Sinner, E. K.; Wolfgang, K. Curr. Opinion Chem. Bio. 2001, 5: 507-711.
15. Gaede, H. C.; Luckett, K. M.; Polozov, I. V.; Gawrisch, K. Langmuir 2004, 20:7711-7719.
16. Ogier, S. D.; Bushby, R. J.; Cheng, Y.; Evans, S. D.; Evand, S. W.; Jenkins, T. A.; Knowles, P. F.; Miles, R. E. Langmuir 2000, 16: 5696-5701.
17. Hennesthal, C.; Steinem, C. J. Am, Chem. Soc. 2000, 122: 8085-8086.
18. Romer, W.; Lam, Y. H.; Fischer, D.; Watts, A.; Fischer, W. B.; Goring, P.; Wehrspohn, R. B.; Gosele, U.; Steinem, C. J. Am. Chem. Soc. 2004, 126: 16267-6274.
19. Drexler, J.; Steinem, C. J. Phys. Chem. B 2003, 107: 11245-11254.
20. Romer, W.; Steinem, C. Biophys. J. 2004, 86: 955-965.
21. O'Brien, M. J.; Bisong, P.; Ista, L. K.; Rabinovich, E. M.; Garcia, A. L.; Sibbett, S. S.; Lopez, G. P.; Brueck, S. R. J. J. Vacuum Sci. Tech. B 2003, 21: 2941-2945.
22. Sanders, C. R.; Oxenoid, K. Biochim. Biophys. Acta-Biomembr. 2000, 1508: 129-145.
23. Marcotte, I.; Auger, M. Concepts Magn. Reson. A 2005, 24A: 17-37.
24. van Dam, L.; Karlsson, G.; Edwards, K. Bioch. Biophys. Acta 2004, 1664: 241-256.
25. Harroun, T. A.; Koslowsky, M.; Nieh, M. P.; de Lannoy, C. F.; Raghunathan, V. A.; Katsaras, J. Langmuir 2005, 21: 5356-5361.
26. Nieh, M. P.; Raghunathan, V. A.; Glinka, C. J.; Harroun, T. A.; Pabst, G.; Katsaras, J. Langmuir 2004, 20: 7893-7897.
27. Triba, M. N.; Warschawski, D. E.; Devaux, P. F. Biophys. J. 2005, 88: 1887-1901.
28. Hauser, H. Biochem. Biophys. Acta 2000, 1508:164-181.
29. Turner, S. W.; Perez, A. M.; Lopez, A.; Craighead, H. G. J. Vacuum Sci. Tech. B 1998, 16:3835-3840.
30. Tokumasu, F.; Jin, A. J.; Feigenson, G. W.; Dvorak, J. A. Biophys. J, 2003, 84:2609-2618.
31. Suzuki, K.; Masuhara, H. Langmuir 2005, 21:6487-6494.
32. Seantier, B.; Breffa, C.; Felix, O.; Decher, G. NanoLetters 2004, 4:5-10.
33. Beckmann, M.; Nollert, P.; Kolb, H. A. J. Membr. Biol. 1998, 161: 227-233.
34. Bayburt, T. H.; Grinkova, Y. V.; Sligar, G. NanoLetters 2002, 2; 853-856.
35. Hennesthal, C.; Drexler, J.; Steinem, C. Chem Phys Chem 2002, 10: 885-889.

We claim:

1. A suspended lipid bilayer comprising a mixture of short-chain and long-chain phospholipids on a solid support, wherein the short-chain and long-chain phospholipids are homogenously distributed throughout the lipid bilayer and the support is such that fluid may flow under the suspended portion of the lipid bilayer.

2. The suspended lipid bilayer of claim 1, wherein the lipids are fluid within the suspended portion of the lipid bilayer.

3. The suspended lipid bilayer of claim 1, wherein the solid support is silica, mica, glass, aluminum, oxidized silicon, semiconductor chips, biochips, silicon wafer, silane-silicon, self assembled monolayer-gold, SnO₂, polymer coated substrates, gold, gold-SAM, or porous Alumina.

4. The suspended lipid bilayer of claim 1, wherein the solid support is oxidized silicon.

5. The suspended lipid bilayer of claim 1, wherein the solid support has a nanotextured surface.

6. The suspended lipid bilayer of claim 5, wherein the nanotextured surface comprises parallel troughs.

7. The suspended lipid bilayer of claim 6, wherein the parallel troughs have a width of about 20 nm to about 500 nm.

8. The suspended lipid bilayer of claim 1 further comprising a biomolecule.

9. The suspended lipid bilayer of claim 1, wherein the suspended lipid bilayer comprises two or more phospholipids selected from a group consisting of 1,2-dipalmitoyl-sn-glycero-3-phosphocholine (DPPC), 1,2-diheptanoyl-sn-glycero-3-phosphocholine (DHPC), 1,2-dihexanoyl-sn-glycero-3-phosphoethanolamine (DHPE), 1,2-dimyristoyl-sn-glycero-3-phosphocholine (DMPC), 1,2-DiODodecyl-sn-Glycero-3-Phosphocholine (DIODPC), 3-(ChlorAmidoPropyl)-dimethylammonio2-Hydroxy-1-Propane Sulfonate (CHAPSO), dimyristoyl phophatidylserine (DMPS), dimyristoyl phosphatidylglycerol, dilauryl phosphatidycholine (DLPC), 1,2-dimyristoyl-sn-glycero-3-phosphoethanolamine (DMPE; 14:0); 1,2-dimyristoyl-sn-glycero-3-[phospho-rac-(1-glycerol)] (Sodium Salt) (DMPG, 14:0), 1-myristoyl-2-hydroxy-sn-glycero-3-phosphocholine (14:0 Lyso PC), 1-oleoyl-2-hydroxy-sn-glycero-3-phosphoethanolamine (18:1 Lyso PE), L-phosphatidylcholine (Egg, Soy), phosphatidylcholine (NBD), 1,1′,2,2′-tetramyristoyl cardiolipin (Ammonium Salt) (14:0), lipids with head groups phosphatidyl serine and phosphatidylinositol, poly(ethylene glycol)-lipid conjugates, fluoroscent lipids-phosphatidylcholine (NBD), 1,2-didecanoyl-sn-glycero-3-phosphocholine (DDPC), 1,2-dierucoyl-sn-glycero-3-phosphate (sodium salt) (DEPA-NA), 1,2-erucoyl-sn-glycero-3-phosphocholine (DEPC), 1,2-dierucoyl-sn-glycero-3-phosphoethanolamine (DEPE), 1,2-linoleoyl-sn-glycero-3-phosphocholine (DLOPC), 1,2-dilauroyl-sn-glycero-3-phosphate (sodium salt) (DLPA-NA), 1,2-dilauroyl-sn-glycero-3-phosphoethanolamine (DLPE), 1,2-dilauroyl-sn-glycero-3-phosphoserine (sodium salt) (DLPS-NA), 1,2-dimyristoyl-sn-glycero-3-phosphate (sodium salt) (DMPA-NA), 1,2-dimyristoyl-sn-glycero-3-phosphoserine (sodium salt) (DMPS-NA), 1,2-dioleoyl-sn-glycero-3-phosphate (sodium salt) (DOPA-NA), 1,2-oleoyl-sn-glycero-3-phosphocholine (DOPC), 1,2-dioleoyl-sn-glycero-3-phosphoethanolamine (DOPE), 1,2-dioleoyl-sn-glycero-3-phosphoserine (sodium salt) (DOPS-NA), 1,2-dipalmitoyl-sn-glycero-3-phosphate (sodium salt) (DPPA-NA), 1,2-dipalmitoyl-sn-glycero-3-phosphoethanolamine (DPPE), 1,2-dipalmitoyl-sn-glycero-3-phosphoserine (sodium salt) (DPPS-NA), 1,2-distearoyl-sn-glycero-3-phosphate (sodium salt) (DSPA-NA), 1,2-distearoyl-sn-glycero-3-phosphocholine (DSPC), 1,2-diostearpyl-sn-glycero-3-phosphoethanolamine (DSPE), 1,2-distearoyl-sn-glycero-3-phosphoserine (sodium salt) DSPS-NA, 1-myristoyl, 2-stearoyl-sn-glycero 3-phosphocholine (MSPC), 1-palmitoyl, 2-myristoyl-sn-glycero 3-phosphocholine (PMPC), 1-palmitoyl, 2-oleoyl-sn-glycero 3-phosphocholine (POPC), 1-palmitoyl-2-oleoyl-sn-glycero-3-phosphoethanolamine (POPE), 1-palmitoyl, 2-stearoyl-sn-glycero 3-phosphocholine (PSPC), 1-stearoyl, 2-myristoyl-sn-glycero 3-phosphocholine (SMPC), 1-stearoyl, 2-palmitoyl-sn-glycero 3-phosphocholine (SOPC), or 1-stearoyl, 2-palmitoyl-sn-glycero 3-phosphocholine (SPPC).

10. The suspended lipid bilayer of claim 1, wherein the long chain phospholipid is DPPC.

11. The suspended lipid bilayer of claim 1, wherein the short chain phospholipid is DHPC.

12. The suspended lipid bilayer of claim 1, further comprising a layer of aqueous solution between the supported lipid bilayer and the solid support.

13. The suspended lipid bilayer of claim 1, wherein the short chain and long chain phospholipids are in a q ratio of about 2.8.

14. A method for making a supported lipid bilayer on a solid support comprising:
(a) mixing an aqueous solution of short-chain phospholipids with long chain phospholipids;
(b) placing the solid support on a drop of the lipid suspension; and
(c) rinsing the solid support with an aqueous solution.

15. The method of claim 14, wherein the aqueous solution further comprises a biomolecule.

16. The method of claim 14, wherein the solid support is silica, mica, glass, aluminum, oxidized silicon, semiconductor chips, biochips, silicon wafer, silane-silicon, self assembled monolayer-gold, SnO₂, polymer coated substrates, gold, gold-SAM, or porous Alumina.

17. The method of claim 14, wherein the solid support has a nanotextured surface.

18. The method of claim 17, wherein the nanotextured surface comprises a series of parallel troughs.

19. The method of claim 18, wherein the parallel troughs have a width of about 20 nm to about 500 nm.

20. The method of claim 14, wherein the short and long chain phospholipids are in a q ratio of about 2.8.
